(19) United States
(12) Patent Application Publication
(10) Pub. No.: US 2026/0290782 A1
(43) Pub. Date: Sep. 24, 2026

(54) METHOD FOR MANUFACTURING ELECTRODE AND ELECTRODE MANUFACTURING APPARATUS

(71) Applicant: SAMSUNG SDI CO., LTD., Yongin-Si (KR)

(72) Inventors: Gwanghun KIM, Yongin-Si (KR); Hyeseong JO, Yongin-Si (KR)

(21) Appl. No.: 19/462,843

(22) Filed: Jan. 28, 2026

(30) Foreign Application Priority Data
Mar. 19, 2025 (KR) 10-2025-0035503

(51) Int. Cl. H01M 4/04; H01M 4/66

(52) U.S. Cl. CPC H01M 4/0435; H01M 4/0404; H01M 4/0471; H01M 4/661; H01M 4/667; H01M 4/668

(57) ABSTRACT

A method for manufacturing an electrode includes: preparing an electrode including a multilayer substrate, and an active material layer formed on at least one surface of the multilayer substrate; transferring the electrode by a transfer unit of an electrode manufacturing apparatus; rolling the transferred electrode by a rolling unit of the electrode manufacturing apparatus; and performing induction heating annealing on the rolling electrode by a heating unit of the electrode manufacturing apparatus. The multilayer substrate includes a metal layer including a first metal layer and a second metal layer opposite to each other, and a polymer layer between the first metal layer and the second metal layer.

### CROSS-REFERENCE TO RELATED APPLICATION

The present application claims priority to and the benefit of Korean Patent Application No. 10-2025-0035503, filed on Mar. 19, 2025, in the Korean Intellectual Property Office, the entire disclosure of which is incorporated by reference herein.

### BACKGROUND

### 1. Field

Aspects of embodiments of the present disclosure relate to a method for manufacturing an electrode, and an electrode manufacturing apparatus.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles, and for storing power (e.g., home and/or utility scale power storage). A secondary battery generally includes an electrode assembly composed of a positive electrode and a negative electrode, a case accommodating the electrode assembly, and electrode terminals connected to the electrode assembly.

Aligned with the advancement of digital convergence, electronic apparatuses and/or vehicles provide various functions and/or various services applied thereto. Accordingly, to improve the function of secondary batteries, which is a central basis for operating electronic apparatuses and/or vehicles, a multilayer substrate, which may include an insulating substrate and metal substrates disposed on both sides (e.g., opposite sides) of the insulating substrate, as an electrode metal substrate in a secondary battery may be used. The multilayer substrate may contribute to a weight reduction in that the multilayer replaces a part of a metal substate with an insulating substrate.

The above information disclosed in this Background section is for the enhancement of understanding of the background of the present disclosure, and therefore, it may contain information that does not constitute related (or prior) art.

### SUMMARY

An electrode of a secondary battery may be manufactured by applying an active material onto a multilayer substrate on at least one side of the multilayer substrate. The electrode may include an active material layer disposed on at least one side of the multilayer substrate, and a non-coated portion where the multilayer substrate is exposed. To increase an energy density, the electrode may be rolled to have a smaller thickness. The active material layer and the non-coated portion may have a mechanical property difference, such as an elongation. Accordingly, when the electrode is rolled, the electrode may be fractured and/or bent.

Embodiments of the present disclosure may be directed to a method for manufacturing an electrode having improved characteristics, and an electrode manufacturing apparatus for the electrode.

The above and additional aspects and features will be set forth, in part, in the description that follows, and in part, may be apparent from the description.

According to one or more embodiments of the present disclosure, a method for manufacturing an electrode includes: preparing an electrode including a multilayer substrate, and an active material layer formed on at least one surface of the multilayer substrate; transferring the electrode by a transfer unit of an electrode manufacturing apparatus; rolling the transferred electrode by a rolling unit of the electrode manufacturing apparatus; and performing induction heating annealing on the rolling electrode by a heating unit of the electrode manufacturing apparatus. The multilayer substrate includes a metal layer including a first metal layer and a second metal layer opposite to each other, and a polymer layer between the first metal layer and the second metal layer.

In an embodiment, the preparing of the electrode may include coating the active material layer to form a non-coated portion where the multilayer substrate is exposed on at least one side of the electrode.

In an embodiment, the rolling of the electrode may include rolling the electrode while the electrode is transferred by the transfer unit at a speed of 10 m/min to 30 m/min.

In an embodiment, the rolling of the electrode may include applying a pressure, by a roller of the rolling unit, in a thickness direction of the electrode to reduce a thickness of the electrode.

In an embodiment, the performing of the induction heating annealing on the electrode may include elongating the non-coated portion by inductively heating at least one surface of the non-coated portion by a coil of the heating unit.

In an embodiment, the performing of the induction heating annealing on the electrode may include inductively heating the electrode with the heating unit at a power consumption of 0.5 kW to 3.0 kW.

In an embodiment, the performing of the induction heating annealing on the electrode may include inductively heating the electrode while the electrode is transferred by the transfer unit at a speed of 0.5 kW to 3.0 kW.

In an embodiment, the polymer layer may include polyethylene terephthalate (PET).

In an embodiment, each of the first metal layer and the second metal layer may include at least one of aluminum (Al) or copper (Cu).

In an embodiment, a thickness of each of the first metal layer and the second metal layer may be smaller than a thickness of the polymer layer.

According to one or more embodiments of the present disclosure, an electrode manufacturing apparatus includes: a transfer unit configured to transfer an electrode including a multilayer substrate, and an active material layer on at least one surface of the multilayer substrate; a rolling unit configured to roll the electrode; and a heating unit located at an exit side of the rolling unit along a transfer direction of the electrode, and configured to induction heating annealing on the electrode. The multilayer substrate includes a metal layer including a first metal layer and a second metal layer opposite to each other, and a polymer layer between the first metal layer and the second metal layer.

In an embodiment, the polymer layer may include polyethylene terephthalate (PET).

In an embodiment, each of the first metal layer and the second metal layer may include at least one of aluminum (Al) or copper (Cu).

In an embodiment, a thickness of each of the first metal layer and the second metal layer may be smaller than a thickness of the polymer layer.

In an embodiment, the electrode may include a non-coated portion where the multilayer substrate is exposed on at least one side of the electrode.

In an embodiment, the heating unit may include a coil to induction heating annealing on at least one surface of the non-coated portion.

In an embodiment, a length of the heating unit may correspond to a width of the non-coated portion with respect to a width direction of the electrode perpendicular to the transfer direction of the electrode.

In an embodiment, the non-coated portion may include portions that are spaced from each other with the active material layer interposed therebetween, and may be located on each of opposite sides of the electrode. The heating unit may include parts that are spaced from each other with a gap therebetween corresponding to a width of the active material layer, and may be located to correspond to the portions of the non-coated portion on both sides of the electrode.

In an embodiment, the transfer unit may be configured to transfer the electrode at a speed of 10 m/min to 30 m/min.

In an embodiment, the rolling unit may include a pair of rolling rollers respectively contacting opposite sides of the electrode, and configured to roll the electrode in a thickness direction of the electrode.

According to some embodiments of the present disclosure, a method for manufacturing an electrode and an apparatus for manufacturing an electrode capable of increasing the energy density of the electrode, and mitigating a fracture and/or a bending of the electrode may be provided.

According to some embodiments of the present disclosure, when an electrode includes a multilayer substrate, a fracture of the electrode may be avoided during rolling, without preheating or elongating, due to mechanical property differences among components of the multilayer substrate.

According to some embodiments of the present disclosure, after an electrode is rolled, a non-coated portion to which a force is applied may be heated and elongated through induction heating annealing (IHA), thereby mitigating a bending of the electrode due to the elongation difference between an active material layer and a non-coated portion.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings, in which:

FIG. 1 is a schematic block diagram illustrating an example of an electrode manufacturing apparatus according to some embodiments of the present disclosure;

FIG. 2 is a perspective view illustrating an example of an electrode according to some embodiments of the present disclosure;

FIG. 3 is a cross-sectional view of an example of an electrode taken along the line A-A’ of FIG. 2;

FIG. 4 is a perspective view illustrating an example of an electrode that is rolled by a rolling unit according to some embodiments of the present disclosure;

FIG. 5 is a side view illustrating an example of an electrode that is rolled by a rolling unit according to some embodiments of the present disclosure;

FIG. 6 is a plan view illustrating an electrode after being rolled according to some embodiments of the present disclosure;

FIG. 7 is a front view illustrating an example of an electrode that is heated by a heating unit according to some embodiments of the present disclosure;

FIG. 8 is a plan view illustrating an example of an electrode after induction heating annealing according to some embodiments of the present disclosure;

FIG. 9 is a flowchart illustrating an example of a method for manufacturing an electrode according to some embodiments of the present disclosure; and

FIG. 10 illustrates views of examples of an electrode manufactured by varying an order and a number of induction heating processes.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature’s relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

Any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in herein is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, and the like as being “the same” as each other may mean that they are “substantially the same” as each other. Thus, the phrase “substantially the same” may include a case having a deviation or a variation that is considered low in the art, for example, such as a deviation or a variation of 5% or less. In addition, when a certain parameter is referred to as being uniform in a given region, it may mean that it is uniform in terms of an average.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being "electrically connected" to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” "includes," "including," "has," "have," and "having," when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression "A and/or B" denotes A, B, or A and B. Expressions such as “at least one of,” when preceding a list of elements, modify the entire list of elements and do not modify the individual elements of the list. For example, the expression "at least one of a, b, or c," “at least one of a, b, and c,” and “at least one selected from the group consisting of a, b, and c” indicates only a, only b, only c, both a and b, both a and c, both b and c, all of a, b, and c, or variations thereof.

As used herein, the term "substantially," "about," and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms "use," "using," and "used" may be considered synonymous with the terms "utilize," "utilizing," and "utilized," respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

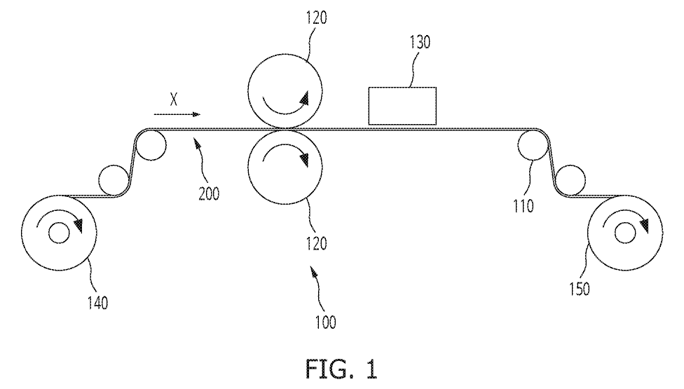

FIG. 1 is a schematic block diagram illustrating an example of an electrode manufacturing apparatus according to some embodiments of the present disclosure.

Referring to FIG. 1, an electrode manufacturing apparatus 100 may include a transfer unit (e.g., a transferrer) 110, a rolling unit (e.g., a roller) 120, a heating unit (e.g., a heater) 130, an unwinding unit (e.g., an unwinder) 140, and a winding unit (e.g., a winder) 150.

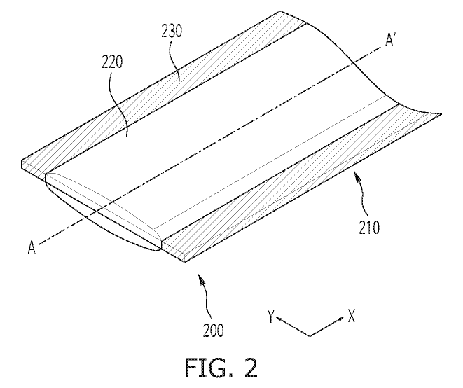

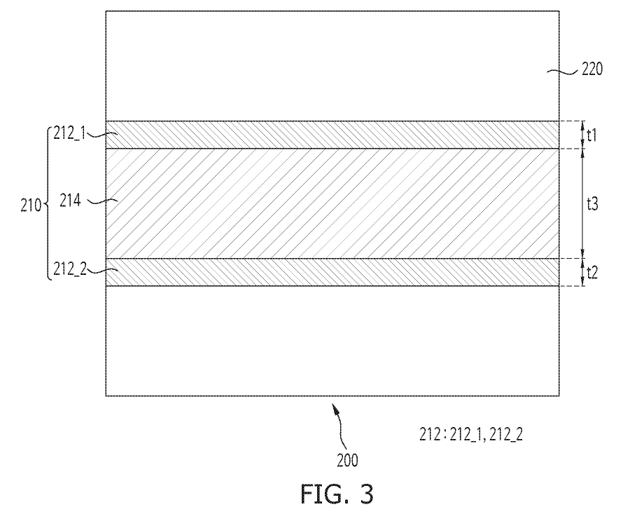

An electrode 200 manufactured by the electrode manufacturing apparatus 100 may include a multilayer substrate, and an active material layer formed on at least one surface of the multilayer substrate. The multilayer substrate may include a metal layer including a first metal layer and a second metal layer opposite to each other, and a polymer layer disposed between the first metal layer and the second metal layer. The electrode 200 will be described in more detail below with reference to FIGS. 2 and 3.

The unwinding unit 140 may include a cylindrical-shaped roller for unwinding the electrode 200. The unwinding unit 140 may be in contact with the electrode 200, and may rotate with respect to a rotational axis, thereby unwinding the electrode 200. The unwinding unit 140 may receive a driving force from a motor connected to the rotational axis, and may unwind the electrode 200. Accordingly, the unwinding unit 140 may unwind the electrode to the rolling unit 120 and the heating unit 130 through the transfer unit 110.

The transfer unit 110 may transfer the electrode 200 that is coated with an active material in a unidirectional manner (e.g., in the X direction). For example, the transfer unit 110 may include a plurality of transfer rollers connected to a driving motor to transfer the electrode 200 that is coated with the active material in a unidirectional manner (e.g., the X direction). According to another example, the transfer unit 110 may include a conveyor belt connected to a driving motor to transfer the electrode 200 that is coated with the active material in a unidirectional manner (e.g., the X direction), but the present disclosure is not limited thereto.

The transfer unit 110 may have a cylindrical shape, and may transfer the electrode 200 unwound by the unwinding unit 140. The width of the transfer unit 110 may be greater than the width of the electrode 200. Therefore, the transfer unit 110 may easily transfer the electrode 200.

The transfer unit 110 may include a non-thermal conductive material. In more detail, the transfer unit 110 may include a suitable material having a resistance, a non-conductivity, and a wear resistance.

A rotational axis of the transfer unit 110 may be formed parallel to or substantially parallel to the rotational axis of the unwinding unit 140. Therefore, the transfer unit 110 may receive the electrode 200 horizontally from the unwinding unit 140. The transfer unit 110 may rotate with respect to the rotational axis to transfer the electrode 200. According to some embodiments, the transfer unit 110 may transfer the electrode 200 at a speed of 10 m/min to 30 m/min.

The rolling unit 120 may apply a pressure in the thickness direction of the electrode 200 to reduce a thickness of the electrode 200. For example, the rolling unit 120 may include a pair of rolling rollers closely attached to both sides (e.g., opposite sides) of the electrode 200, respectively, and may roll the electrode 200 in the thickness direction. The pair of rolling rollers may be disposed on the upper surface and the lower surface of the electrode 200, respectively. The pair of rolling rollers may be disposed to have a gap (e.g., a predetermined gap) therebetween. The electrode 200 transferred by the transfer unit 110 may be inserted into the gap between the pair of rolling rollers, and the pair of rolling rollers may apply a pressure to the inserted electrode 200 to adhere the active material to the multilayer substrate of the electrode 200.

The heating unit 130 may be disposed on an exit side of the rolling unit 120 along the transfer direction (e.g., the X direction) of the electrode 200. Accordingly, the heating unit 130 may heat the electrode 200 rolled by the rolling unit 120.

The heating unit 130 may include a coil for performing induction heating annealing (IHA) on at least one side of the non-coated portion of the electrode 200. The electrode 200 may be transferred through the transfer unit 110 from the lower side of the heating unit 130. When the electrode 200 is transferred, the coil may perform induction heating annealing on the non-coated portion.

The winding unit 150 may have a cylindrical shape, and may transport the electrode 200 received from the transfer unit 110. The winding unit 150 may contact the electrode 200, and may rotate with respect to a rotational axis to wind the electrode 200. The winding unit 150 may have its rotational axis parallel to or substantially parallel to the rotational axis of the transfer unit 110. Therefore, the winding unit 150 may receive the electrode 200 horizontally from the transfer unit 110. The rotational axis of the winding unit 150 may be connected to a motor to receive a rotational force, and may wind the electrode 200.

FIG. 2 is a perspective view illustrating an example of an electrode according to some embodiments of the present disclosure.

Referring to FIG. 2, an electrode 200 may include a multilayer substrate 210, and an active material layer 220 formed on at least one surface of the multilayer substrate 210.

According to some embodiments, the multilayer substrate 210 may have a band-shaped structure that extends in one direction. The active material layer 220 may extend to have a width (e.g., a predetermined width) along a length direction (e.g., the X-direction) of the multilayer substrate 210. The active material layer 220 may be coated onto a central area of the multilayer substrate 210 along the length direction.

According to some embodiments, the electrode 200 may include a non-coated portion 230 where the multilayer substrate 210 is exposed on at least one side of the electrode 200. For example, the non-coated portion 230 may be formed on both sides (e.g., opposite sides) of the active material layer 220 along the length direction (e.g., the X-direction) of the multilayer substrate 210. The non-coated portion 230 may be spaced apart from each other with the active material layer 220 interposed therebetween, and may be disposed on each side of the electrode 200. As another example, the non-coated portion 230 may be formed on one side (e.g., on only one side) of the electrode 200.

According to some embodiments, when the electrode 200 is formed of a positive electrode, the active material layer 220 may include a positive electrode active material.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and suitable combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a suitable combination thereof.

As an example, a compound represented by any one of the following formulas may be used: LiaA1-bXbO2-cDc (0.90≤a≤1.8, 0≤b≤0.5, 0≤c≤0.05); LiaMn2-bXbO4-cDc (0.90≤a≤1.8, 0≤b≤0.5, 0≤c≤0.05); LiaNi1-b-cCobXcO2-αDα (0.90≤a≤1.8, 0≤b≤0.5, 0≤c≤0.5, 0<α<2); LiaNi1-b-cMnbXcO2-αDα (0.90≤a≤1.8, 0≤b≤0.5, 0≤c≤0.5, 0<α<2); LiaNibCocL1dGeO2 (0.90≤a≤1.8, 0≤b≤0.9, 0≤c≤0.5, 0≤d≤0.5, 0≤e≤0.1); LiaNiGbO2 (0.90≤a≤1.8, 0.001≤b≤0.1); LiaCoGbO2 (0.90≤a≤1.8, 0.001≤b≤0.1); LiaMn1-bGbO2 (0.90≤a≤1.8, 0.001≤b≤0.1); LiaMn2GbO4 (0.90≤a≤1.8, 0.001≤b≤0.1); LiaMn1-gGgPO4 (0.90≤a≤1.8, 0≤g≤0.5); Li(3-f)Fe2(PO4)3 (0≤f≤2); and LiaFePO4 (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol%, greater than or equal to about 85 mol%, greater than or equal to about 90 mol%, greater than or equal to about 91 mol%, or greater than or equal to about 94 mol% and less than or equal to about 99 mol% based on 100 mol% of the metal excluding lithium in the lithium transition metal composite oxide. The high-nickel-based positive electrode active material may be capable of realizing high capacity and can be applied to a high-capacity, high-density rechargeable lithium battery.

According to some embodiments, when the electrode 200 is formed of a negative electrode, the active material layer 220 may include a negative electrode active material.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a suitable combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0 < x < 2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a suitable combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

FIG. 3 is a cross-section view illustrating an example of an electrode taken along the line A-A’ of FIG. 2.

Referring to FIG. 3, the electrode 200 may include a multilayer substrate 210, and an active material layer 220 formed on at least one side of the multilayer substrate 210. The multilayer substrate 210 may include a metal layer 212 including a first metal layer 212_1 and a second metal layer 212_2 facing or opposite to each other, and a polymer layer 214 disposed between the first metal layer 212_1 and the second metal layer 212_2.

According to some embodiments, the first metal layer 212_1 and the second metal layer 212_2 may each be coated on the polymer layer 214 with a suitable metal material, such as copper (Cu), a copper alloy, nickel (Ni), or a nickel alloy, or may be coated with a suitable metal material, such as aluminum (Al) or an aluminum alloy. The first metal layer 212_1 and the second metal layer 212_2 may be formed of the same metal material as each other, and may function as a positive electrode or a negative electrode.

According to some embodiments, the polymer layer 214 may include a polymer material. For example, the polymer layer 214 may include a polyethylene terephthalate (PET) resin. The material of the polymer layer 214 is not limited thereto, and may include polyester-based resins, such as polytrimethyleneterephthalate (PTT), polybutyleneterephthalate) (PBT), or polyethylenenaphthalate) (PEN), or the like. With the polymer layer 214 including a polymer resin, a flexibility and a light weight of the electrode 200 may be secured.

According to some embodiments, thicknesses t1 and t2 of the first metal layer 212_1 and the second metal layer 212_2, respectively, may be smaller than a thickness t3 of the polymer layer 214. When the first metal layer 212_1 and the second metal layer 212_2 include aluminum (Al), a ratio of the respective thicknesses t1 and t2 of the first metal layer 212_1 and the second metal layer 212_2 to the thickness t3 of the polymer layer 214 may be 1:8 to 1:6. When the first metal layer 212_1 and the second metal layer 212_2 include copper (Cu), a ratio of the respective thicknesses t1 and t2 of the first metal layer 212_1 and the second metal layer 212_2 to the thickness t3 of the polymer layer 214 may be 2:9. However, the ratio of the respective thicknesses t1 and t2 of the first metal layer 212_1 and the second metal layer 212_2 to the thickness t3 of the polymer layer 214 are not limited thereto. Accordingly, a tensile strength of the polymer layer 214 may be lower than that of the metal layer 212. An elongation at break of the polymer layer 214 may be higher than that of the metal layer 212. The tensile strength may refer to the maximum stress and/or force magnitude that a material may withstand before breaking when subjected to an external pulling force. The elongation at break may refer to the ratio indicating a degree of elongation until the material is fractured.

Due to the difference in mechanical properties of the composition of the multilayer substrate 210 as described above, the electrode 200 may not be fractured even though the electrode 200 is rolled by the rolling unit of the electrode manufacturing apparatus. In more detail, the electrode 20 may not be fractured even though the electrode 200 is rolled without heating and elongating the non-coated portion. After the electrode 200 is rolled, a tension may be applied to the non-coated portion due to the difference in elongation between the active material layer and the non-coated portion. When the non-coated portion, which is under the tension, is heated and elongated using an Induction Heating Annealing (IHA) process, the electrode bending and/or fracturing that may be caused by the elongation difference between the active material layer and the non-coated portion may be overcome.

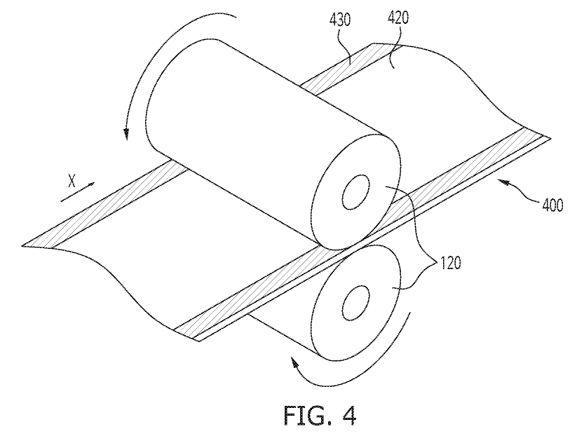

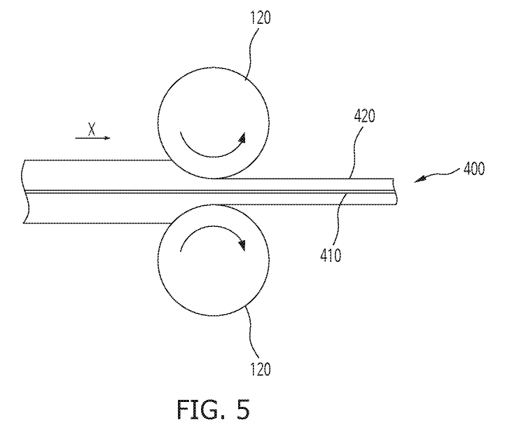

FIG. 4 is a perspective view illustrating an example of an electrode that is rolled by a rolling unit according to some embodiments of the present disclosure. FIG. 5 is a side view illustrating an example of an electrode that is rolled by a rolling unit according to some embodiments of the present disclosure.

Referring to FIGS. 4 and 5, an electrode 400 may include an active material layer 420, and non-coated portions 430 spaced apart from each other with the active material layer 420 interposed therebetween. The non-coated portions 430 may be disposed on each side (e.g., opposite sides) of the electrode 400. The electrode 400 may be rolled by a rolling unit (e.g., a roller) 120 including a pair of rolling rollers.

According to some embodiments, the rolling unit 120 may include a pair of rolling rollers that may closely contact both sides (e.g., opposite sides) of the electrode 400, and may roll the electrode 400 in the thickness direction of the electrode 400. The pair of rolling rollers may continuously transfer and roll the electrode 400.

According to some embodiments, the rolling unit 120 may roll the electrode 400 when the electrode 400 is transferred by the transfer unit at a speed of 10 m/min to 30 m/min.

Through the rolling unit 120, the electrode 400 may be processed to reduce its overall thickness, and may achieve a uniformly consistent thickness. With the close contact between a multilayer substrate 410 and the active material layer 420, the electrode 400 may achieve an increased adhesion between the multilayer substrate 410 and the active material layer 420. Therefore, the electrode 400 may have a higher density of the active material layer 420, thereby improving the energy density of the electrode 400.

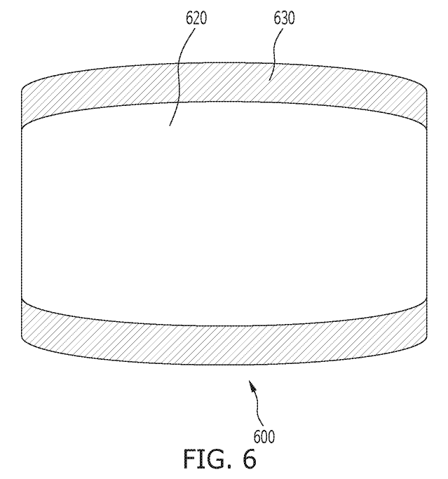

FIG. 6 is a plan view illustrating an example of an electrode after being rolled according to some embodiments of the present disclosure.

Referring to FIG. 6, an electrode 600 that is rolled may be in a state in which a tension is applied to a non-coated portion 630 due to the difference in elongation between an active material layer 620 and the non-coated portion 630. Accordingly, the electrode 600 may be bent or curved. However, due to the difference in mechanical properties between the components of the multilayer substrate 210 (e.g., refer to FIG. 3) described above, even though the electrode 600 is rolled, the electrode 600 may not be fractured. In more detail, even though the electrode 600 is rolled without heating and elongating the non-coated portion 630, the fracturing of the electrode 600 may not occur.

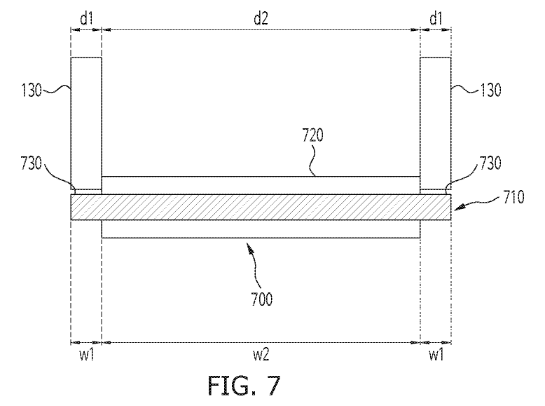

FIG. 7 is a front view illustrating an example of an electrode that is heated by a heating unit according to some embodiments of the present disclosure.

Referring to FIG. 7, the heating unit 130 may perform induction heating annealing (IHA) on an electrode 700. The electrode 700 may include a multilayer substrate 710, an active material layer 720 disposed on both sides (e.g., opposite sides) of the multilayer substrate 710, and non-coated portions 730 spaced apart from each other with the active material layer 720 interposed therebetween and disposed on both sides (e.g., opposite sides) of the electrode 700.

According to some embodiments, the heating unit 130 may include a coil for performing induction heating annealing (IHA) on the non-coated portions 730 of the electrode 700. The heating unit 130 may be formed to have a length d1 corresponding to a width w1 of the non-coated portion 730. The coil may be made of a metal having a high thermal conductivity. The heating unit 130 may be disposed on the upper side of the electrode 700. The electrode 700 may be transferred by a transfer unit (e.g., a transferer) to the lower side of the heating unit 130. Accordingly, the coil may perform induction heating annealing (IHA) on the non-coated portion 730 when the electrode 700 is transferred. Induction heating annealing (IHA) may refer to a process of heating a conductive material including a metal through electromagnetic induction. Therefore, in the case of elongating the non-coated portion 730 of the electrode 700 to which a tension is applied through induction heating annealing, curving and/or bending of the electrode 700 that may be caused by the elongation difference between the active material layer 720 and the non-coated portion 730 may be prevented or substantially prevented.

According to some embodiments, the electrode 700 may include the non-coated portion 730 where the multilayer substrate 710 is exposed on at least one side of the electrode 700. For example, the non-coated portions 730 may be spaced apart from each other with the active material layer 720 interposed therebetween, and may be disposed on both sides (e.g., opposite sides) of the electrode 700.

According to some embodiments, the heating unit 130 may be arranged to correspond to at least one side where the non-coated portions 730 of the electrode 700 is formed. For example, the heating unit 130 may be spaced apart from each other to correspond to both sides where the non-coated portion 730 of the electrode 700 is formed. In more detail, the heating unit 130 may be spaced apart from each other with a distance d2 corresponding to a width w2 of the active material layer 720, and may be arranged respectively to correspond to the non-coated portion 730 formed on both sides of the electrode 700.

According to some embodiments, based on the width direction of the electrode 700 perpendicular to or substantially perpendicular to the transfer direction of the electrode 700, a length d1 of the heating unit 130 may correspond to the width w1 of the non-coated portion 730. As used herein, “correspond to” may indicate that the length d1 of the heating unit 130 is equal to the width w1 of the non-coated portion 730, or is substantially equal thereto within a suitable margin of error (e.g., a predetermined margin of error).

According to some embodiments, the heating unit 130 may perform induction heating annealing (IHA) on the non-coated portion 730 of the electrode 700 to generate heat within the multilayer substrate 710. The heating unit 130 may achieve a high temperature within a short period of time by inductively heating the non-coated portion 730 through a coil. Therefore, the heating unit 130 may perform a sufficient heat treatment in a relatively short period of time of approximately 1 to 5 seconds.

According to some embodiments, the heating unit 130 may have a power consumption based on the heating time and a target temperature. For example, the electrode 700 may be inductively heated by the heating unit at a power consumption of 0.5 kW and 3.0 kW.

According to some embodiments, the heating unit 130 may perform induction heating annealing on the electrode 700 when (e.g., while) the electrode 700 is being transferred by the transfer unit. In more detail, the heating unit 130 may perform induction heating annealing on the electrode 700 when the electrode 700 is being transferred by the transfer unit at a speed of 10 m/min to 30 m/min. However, the present disclosure is not limited thereto, and the heating unit 130 may perform induction heating annealing on the electrode 700 when the transfer of the electrode 700 is stopped.

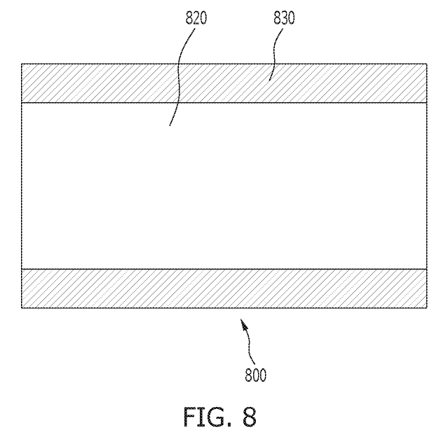

FIG. 8 is a plan view illustrating an example of an electrode after induction heating annealing according to some embodiments of the present disclosure.

Referring to FIG. 8, an electrode 800 that is elongated by induction heating annealing (IHA) may have a reduced curvature. The rolled electrode 600 (e.g., refer to FIG. 6) may be in a state in which a tension is applied to the non-coated portion due to the elongation difference between the active material layer and the non-coated portion. In more detail, when the tension-applied non-coated portion of the electrode is elongated by induction heating annealing, a curving and/or a bending of the electrode 800 that may be caused by the elongation difference between an active material layer 820 and a non-coated portion 830 may be reduced or prevented. When elongating the non-coated portion 830, a fracture of the non-coated portion 830 due to a damage to the non-coated portion 830 may be reduced or prevented.

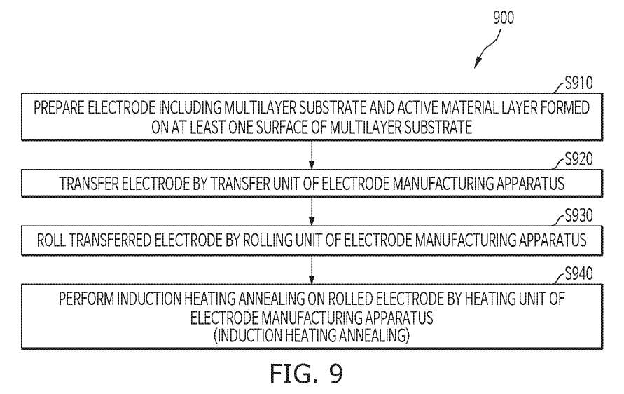

FIG. 9 is a flowchart illustrating an example of a method for manufacturing an electrode according to some embodiments of the present disclosure.

A method for manufacturing an electrode 900 may start, and an electrode including a multilayer substrate, and an active material layer formed on at least one side of the multilayer substrate may be prepared (S910). The multilayer substrate may include a metal layer including a first metal layer and a second metal layer facing or opposite to each other, and a polymer layer disposed between the first metal layer and the second metal layer. According to some embodiments, the polymer layer may include polyethylene terephthalate (PET). The first metal layer and the second metal layer may each include at least one of aluminum (Al) or copper (Cu). The thickness of each of the first metal layer and the second metal layer may be smaller than the thickness of the polymer layer.

According to some embodiments, the preparing of the electrode S910) may include coating an active material to form a non-coated portion where the multilayer substrate is exposed on at least one side of the electrode. As a result, the non-coated portion my include portions that are spaced apart from each other with the active material layer interposed therebetween, and disposed on both sides of the electrode.

The electrode may be transferred by a transfer unit (e.g., a transferrer) of an electrode manufacturing apparatus (S920).

The transferred electrode may be rolled by a rolling unit (e.g., a roller) of the electrode manufacturing apparatus (S930).

According to some embodiments, the rolling of the electrode (S930) may include rolling the electrode when the electrode is transferred by the transfer unit at a speed of 10 m/min to 30 m/min.

According to some embodiments, the rolling of the electrode (S930) may include applying a pressure in the thickness direction of the electrode by rollers of the rolling unit to reduce a thickness of the electrode. According to some embodiments, the rolling unit may include a pair of rolling rollers in close contact with both surfaces (e.g., opposite surfaces) of the electrode to roll the electrode in the thickness direction. The pair of rolling rollers may continuously transfer and roll the electrode.

The rolled electrode may be inductively heated (e.g., Induction Heating Annealing, IHA) by the heating unit of the electrode manufacturing apparatus (S940). The heating unit may be disposed on an exit side of the rolling unit along the electrode transfer direction. Accordingly, the heating unit may heat the electrode rolled by the rolling unit.

According to some embodiments, the induction heating annealing (IHA) of the electrode (S940) may include elongating a non-coated portion by induction heating on at least one side of the non-coated portion by using a coil of the heating unit. The heating unit may be formed to have a suitable length corresponding to the width of the non-coated portion. The coil may be made of a metal having a high thermal conductivity. The heating unit may be disposed above the electrode. The electrode may be transferred by the transfer unit to the lower side of the heating unit. Accordingly, the coil may perform induction heating annealing (IHA) on the non-coated portion when (e.g., while) the electrode is transferred. Induction heating annealing (IHA) may refer to a process of heating a conductive material including a metal through electromagnetic induction.

According to some embodiments, the induction heating annealing (IHA) of the electrode (S940) may include induction heating annealing of the electrode by the heating unit at a power consumption of 0.5 kW and 3.0 kW. However, the present disclosure is not limited thereto, and the heating unit may have various suitable power consumption levels depending on the heating time and a target temperature.

According to some embodiments, the induction heating annealing (IHA) of the electrode (S940) may include induction heating annealing of the electrode when (e.g., while) the electrode is transferred by the transfer unit at a speed of 10 m/min to 30 m/min. However, the present disclosure is not limited thereto, and the heating unit may inductively heat the electrode when the transfer of the electrode is stopped.

However, the present disclosure is not limited to the flow chart of FIG. 9 described above. For example, one or more processes may be added/changed/deleted, the order of one or more processes may be changed, and/or one or more processes may be performed concurrently (e.g., simultaneously or substantially simultaneously) with each other.

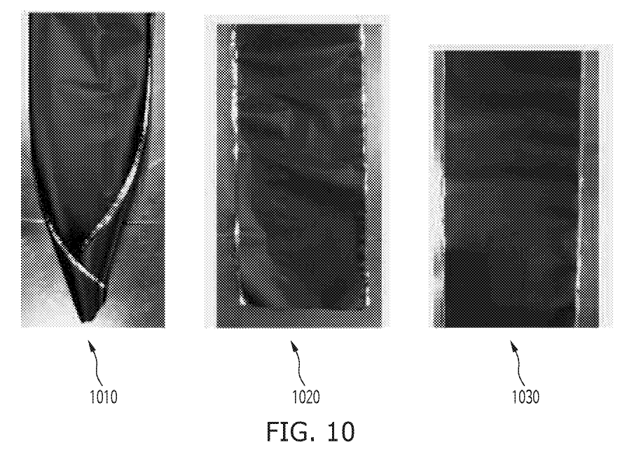

FIG. 10 illustrates views of examples of an electrode manufactured by varying an order and a number of induction heating annealing processes.

Referring to FIG. 10, a first example 1010 may indicate an electrode rolled after induction heating annealing (IHA). The electrode may be inductively heated (IHA) and rolled when (e.g., while) transferred at a speed of approximately 20 m/min. The electrode may be heated at a power consumption of the induction heating annealing (IHA) of approximately 1.7 kW. The thickness of the electrode may be approximately 100 μm, and the density of the active material layer may be approximately 4 kg/m³. According to the first example 1 1010, prominent surface wrinkles may form on the electrode, and a degree of curvature of the electrode may be intensified to an extent that may not be suitably measured, which may consequently affect a functionality of the electrode.

A second example 1020 may indicate an electrode manufactured by induction heating annealing (IHA) before and after rolling. When the electrode is transferred at a speed of approximately 10 m/min, the electrode may be inductively heated (IHA) and rolled. The electrode may be heated at a power consumption of the induction heating annealing (IHA) of approximately 0.9 kW. According to the second example 1020, prominent surface wrinkles may form on the electrode, and a degree of curvature of the electrode may become intensified to be approximately 16 mm, which may consequently affect a functionality of the electrode.

A third example 1030 may indicate an electrode inductively heated (IHA) after rolling. The electrode may be inductively heated (IHA) and rolled when transferred at a speed of approximately 20 m/min. The electrode may be heated so that a power consumption of the induction heating annealing (IHA) may be approximately 2.4 kW. The thickness of the electrode may be approximately 100 μm, and the density of the active material layer may be approximately 4 kg/m³. According to the third example 1030, surface wrinkles that may be form on the electrode may be sufficiently fine to be regarded as being nearly absent when the curvature is reduced to approximately 3 mm. Therefore, a defect rate of the manufactured electrode may be reduced, and a winding amount during electrode winding may be improved.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

### DESCRIPTION OF SOME REFERENCE SYMBOLS

101: Electrode Manufacturing Apparatus

110: Transfer Unit

120: Rolling Unit

130: Heating Unit

140: Unwinding Unit

150: Winding Unit

200: Electrode

210: Multilayer Substrate

212_1: First Metal Layer

212_2: Second Metal Layer

214: Polymer Layer

220: Active Material Layer

230: Non-coated Portion

What is claimed is:

1. A method for manufacturing an electrode, the method comprising:
preparing an electrode comprising a multilayer substrate, and an active material layer formed on at least one surface of the multilayer substrate;
transferring the electrode by a transfer unit of an electrode manufacturing apparatus;
rolling the transferred electrode by a rolling unit of the electrode manufacturing apparatus; and
performing induction heating annealing on the rolling electrode by a heating unit of the electrode manufacturing apparatus,
wherein the multilayer substrate comprises a metal layer comprising a first metal layer and a second metal layer opposite to each other, and a polymer layer between the first metal layer and the second metal layer.

2. The method as claimed in claim 1, wherein the preparing of the electrode comprises coating the active material layer to form a non-coated portion where the multilayer substrate is exposed on at least one side of the electrode.

3. The method as claimed in claim 1, wherein the rolling of the electrode comprises rolling the electrode while the electrode is transferred by the transfer unit at a speed of 10 m/min to 30 m/min.

4. The method as claimed in claim 1, wherein the rolling of the electrode comprises applying a pressure, by a roller of the rolling unit, in a thickness direction of the electrode to reduce a thickness of the electrode.

5. The method as claimed in claim 2, wherein the performing of the induction heating annealing on the electrode comprises elongating the non-coated portion by inductively heating at least one surface of the non-coated portion by a coil of the heating unit.

6. The method as claimed in claim 1, wherein the performing of the induction heating annealing on the electrode comprises inductively heating the electrode with the heating unit at a power consumption of 0.5 kW to 3.0 kW.

7. The method as claimed in claim 1, wherein the performing of the induction heating annealing on the electrode comprises inductively heating the electrode while the electrode is transferred by the transfer unit at a speed of 0.5 kW to 3.0 kW.

8. The method as claimed in claim 1, wherein the polymer layer comprises polyethylene terephthalate (PET).

9. The method as claimed in claim 1, wherein each of the first metal layer and the second metal layer comprises at least one of aluminum (Al) or copper (Cu).

10. The method as claimed in claim 1, wherein a thickness of each of the first metal layer and the second metal layer is smaller than a thickness of the polymer layer.

11. An electrode manufacturing apparatus comprising:
a transfer unit configured to transfer an electrode comprising a multilayer substrate, and an active material layer on at least one surface of the multilayer substrate;
a rolling unit configured to roll the electrode; and
a heating unit located at an exit side of the rolling unit along a transfer direction of the electrode, and configured to induction heating annealing on the electrode,
wherein the multilayer substrate comprises a metal layer comprising a first metal layer and a second metal layer opposite to each other, and a polymer layer between the first metal layer and the second metal layer.

12. The electrode manufacturing apparatus as claimed in claim 11, wherein the polymer layer comprises polyethylene terephthalate (PET).

13. The electrode manufacturing apparatus as claimed in claim 11, wherein each of the first metal layer and the second metal layer comprises at least one of aluminum (Al) or copper (Cu).

14. The electrode manufacturing apparatus as claimed in claim 11, wherein a thickness of each of the first metal layer and the second metal layer is smaller than a thickness of the polymer layer.

15. The electrode manufacturing apparatus as claimed in claim 11, wherein the electrode comprises a non-coated portion where the multilayer substrate is exposed on at least one side of the electrode.

16. The electrode manufacturing apparatus as claimed in claim 15, wherein the heating unit comprises a coil to induction heating annealing on at least one surface of the non-coated portion.

17. The electrode manufacturing apparatus as claimed in claim 15, wherein a length of the heating unit corresponds to a width of the non-coated portion with respect to a width direction of the electrode perpendicular to the transfer direction of the electrode.

18. The electrode manufacturing apparatus as claimed in claim 15, wherein the non-coated portion comprises portions that are spaced from each other with the active material layer interposed therebetween, and is located on each of opposite sides of the electrode, and
wherein the heating unit comprises parts that are spaced from each other with a gap therebetween corresponding to a width of the active material layer, and located to correspond to the portions of the non-coated portion on both sides of the electrode.

19. The electrode manufacturing apparatus as claimed in claim 11, wherein the transfer unit is configured to transfer the electrode at a speed of 10 m/min to 30 m/min.

20. The electrode manufacturing apparatus as claimed in claim 11, wherein the rolling unit comprises a pair of rolling rollers respectively contacting opposite sides of the electrode, and configured to roll the electrode in a thickness direction of the electrode.
